(19) United States
(12) Patent Application Publication
(10) Pub. No.: US 2015/0109269 A1
(43) Pub. Date: Apr. 23, 2015

(54) STEREOSCOPIC IMAGE DISPLAY DEVICE AND METHOD FOR DRIVING THE SAME

(71) Applicant: Samsung Display Co., LTD., Yongin-City (KR)

(72) Inventors: Jeong-Min SUNG, Yongin-City (KR); Kang-Min KIM, Yongin-City (KR); Sung-Woo LEE, Yongin-City (KR)

(21) Appl. No.: 14/516,944

(22) Filed: Oct. 17, 2014

(30) Foreign Application Priority Data
Oct. 18, 2013 (KR) 10-2013-0124404

(51) Int. Cl. G09G 3/36; G02F 1/133; G02B 27/22

(52) U.S. Cl. CPC G09G 3/3696; G02B 27/2214; G02F 1/13306
USPC 345/206; 345/99

(57) ABSTRACT

A stereoscopic image display device includes: a display panel including pixels; a liquid crystal lens panel disposed above the display panel, where the liquid crystal lens panel includes a first substrate, a second substrate disposed opposite to the first substrate, division electrodes disposed on the first substrate, a common electrode disposed on the second substrate, and a liquid crystal layer disposed between the first and second substrate; a common voltage supply unit configured to supply a common voltage to the common electrode; and a driving voltage supply unit configured to supply driving voltages to the division electrodes, where the liquid crystal layer of the liquid crystal lens panel is implemented as lenses by an electric field generated based on the driving voltages supplied to the division electrodes and the common voltage supplied to the common electrode, and the common voltage is driven as an alternating current voltage.

This application claims priority to Korean Patent Application No. 10-2013-0124404, filed on Oct. 18, 2013, and all the benefits accruing therefrom under 35 U.S.C. §119, the content of which in its entirety is herein incorporated by reference.

### BACKGROUND

1. Field

Exemplary embodiments of the invention relate to a stereoscopic image display device and a method for driving the stereoscopic image display device.

2. Description of the Related Art

A stereoscopic image display implements a three-dimensional (“3D”) image using a stereoscopic technique and an autostereoscopic technique. The stereoscopic technique uses a parallax image between left and right eyes of a user with a high stereoscopic effect. The stereoscopic technique is classified into a glasses type method and a non-glasses type method.

The glasses type method may include a patterned retarder method and a shutter glasses method. In the patterned retarder method, polarization directions of left and right parallax images are changed to display the left and right parallax images on a direct-view-type display device or projector and implement a stereoscopic image using polarization glasses. In the shutter glasses method, left and right parallax images are displayed on a direct-view-type display device or projector in a time-division manner to implement a stereoscopic image using liquid crystal shutter glasses.

In the non-glasses type method, an optical axis of the parallax image between the left and right eyes is generally separated using an optical plate such as a parallax barrier and a lenticular lens, and thus the stereoscopic image is implemented.

Recently, the non-glasses type method, which allows a user to watch a stereoscopic image without wearing shutter glasses or polarized glasses, has been widely applied to medium- and small-sized displays such as smart phones, tablet computers and notebook computers. However, the luminance of a two-dimensional (“2D”) image displayed by the non-glasses type method using the parallax barrier may be reduced, and the 2D image may be distorted by the lenticular lens used in the non-glasses type method.

### SUMMARY

Exemplary embodiments provide a stereoscopic image display device and a method for driving the stereoscopic image display device, which minimizes the difference between luminances of an image during two consecutive frame periods, e.g., difference between the luminance of an N-th (here, N is a positive integer) frame period and the luminance of an image during an (N+1)-th frame period, which may occur by a liquid crystal lens panel.

According to an exemplary embodiment of the invention, a stereoscopic image display device includes: a display panel including a plurality of pixels; a liquid crystal lens panel disposed above the display panel, where the liquid crystal lens panel includes a first substrate, a second substrate disposed opposite to the first substrate, division electrodes disposed on the first substrate, a common electrode disposed on the second substrate, and a liquid crystal layer disposed between the first and second substrate; a common voltage supply unit configured to supply a common voltage to the common electrode; and a driving voltage supply unit configured to supply driving voltages to the division electrodes, where the liquid crystal layer of the liquid crystal lens panel is implemented as a plurality of lenses by an electric field generated based on the driving voltages supplied to the division electrodes and the common voltage supplied to the common electrode, and the common voltage is driven as an alternating current (“AC”) voltage.

According to an exemplary embodiment of the invention, a method of driving a stereoscopic image display device including a display panel, and a liquid crystal lens panel disposed above the display panel, the method including: transmitting light incident onto a liquid crystal layer of the liquid crystal lens panel without refraction in a two-dimensional mode, where the liquid crystal layer is disposed between a first substrate and a second substrate of the liquid crystal lens panel, which are disposed opposite to each other; and generating an electric field based on driving voltages and a common voltage supplied to the liquid crystal lens panel in a three-dimensional mode to implement the liquid crystal layer as a plurality of lenses, where the driving voltages are supplied to division electrodes disposed in the first substrate of the liquid crystal lens panel and the common voltage is supplied to a common electrode disposed in the second substrate of the liquid crystal lens panel, where the common voltage is driven as an AC voltage in the three-dimensional mode.

### BRIEF DESCRIPTION OF THE DRAWINGS

The above and other features of the invention will become more apparent by describing in detail exemplary embodiments thereof with reference to the attached drawings, in which:

FIG. 1 is a block diagram illustrating an exemplary embodiment of a stereoscopic image display device, according to the invention;

FIG. 2 is a circuit diagram illustrating an exemplary embodiment of a pixel of a display panel shown in FIG. 1;

FIG. 3 is a cross-sectional view of an exemplary embodiment of the display panel and a liquid crystal lens, shown in FIG. 1;

FIG. 4 is a cross-sectional view of an exemplary embodiment of a convex lens;

FIG. 5 is a cross-sectional view of an exemplary embodiment of a Fresnel lens;

FIG. 6 is a cross-sectional view of the liquid crystal lens panel, in which a liquid crystal layer is implemented as the Fresnel lens;

FIG. 7 is a diagram illustrating a common voltage supplied to a common electrode and driving voltages supplied to division electrodes in an exemplary embodiment during an N-th frame period;

FIG. 8 is a diagram illustrating a common voltage supplied to the common electrode and driving voltages supplied to the division electrodes in an exemplary embodiment during an (N+1)-th frame period;

FIG. 9 is a block diagram illustrating an exemplary embodiment of a liquid crystal lens panel driver, according to the invention.; and

FIG. 10 is a circuit diagram illustrating an exemplary embodiment of a common voltage supply unit of FIG. 9.

### DETAILED DESCRIPTION

The invention will be described more fully hereinafter with reference to the accompanying drawings, in which embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

In an exemplary embodiment, a non-glasses type method using a liquid crystal lens panel is provided to improve the luminance of a two-dimensional (“2D”) image displayed by the non-glasses type method and to effectively prevent the distortion in the 2D image by the lenticular lens of the non-glasses type method. The liquid crystal lens panel controls liquid crystal molecules of a liquid crystal layer by applying an electric field to the liquid crystal molecules. Thus, the liquid crystal lens panel allows light incident thereonto to be transmitted as it is, e.g., without refraction, in the 2D mode, and functions as a lens in a three-dimensional (“3D”) mode.

In an exemplary embodiment of the liquid crystal lens panel, a common voltage is applied to a common electrode, and driving voltages having a positive or negative polarity with respect to the common voltage are applied to division electrodes. Thus, the liquid crystal lens panel may control the liquid crystal molecules of the liquid crystal layer by applying an electric field to the liquid crystal molecules. The average polarity of the driving voltages supplied to the liquid crystal lens panel may be biased to the positive or negative polarity according to a frame period. When the average polarity of the driving voltages supplied to the liquid crystal lens panel may be biased to the positive polarity during an N-th (here, N is a natural number) frame period, and may be biased to the negative polarity during an (N+1)-th frame period. In this case, a difference between the luminance of an image during the N-th frame period and the luminance of an image during the (N+1)-th frame period may occur due to the difference in the response characteristic and resistive-capacitive (“RC”) delay of the liquid crystal molecules between the positive and negative polarities. Accordingly, a user may recognize flickering in which a periodic change in the luminance of a display device is recognized through a visual angle. Therefore, the user may feel inconvenience in watching 2D or 3D images.

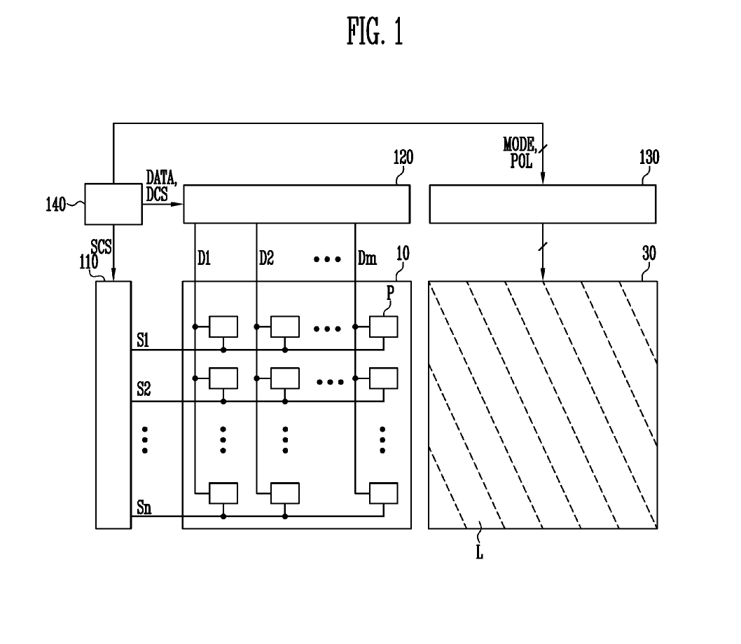

An exemplary embodiment of the invention is provided to improve the luminance of a two-dimensional (“2D”) image displayed by the non-glasses type method and to effectively prevent the distortion in the 2D image by the lenticular lens of the non-glasses type method, as described above. Hereinafter, an exemplary embodiment of the invention will be described in detail with reference to FIGS. 1 to 10.

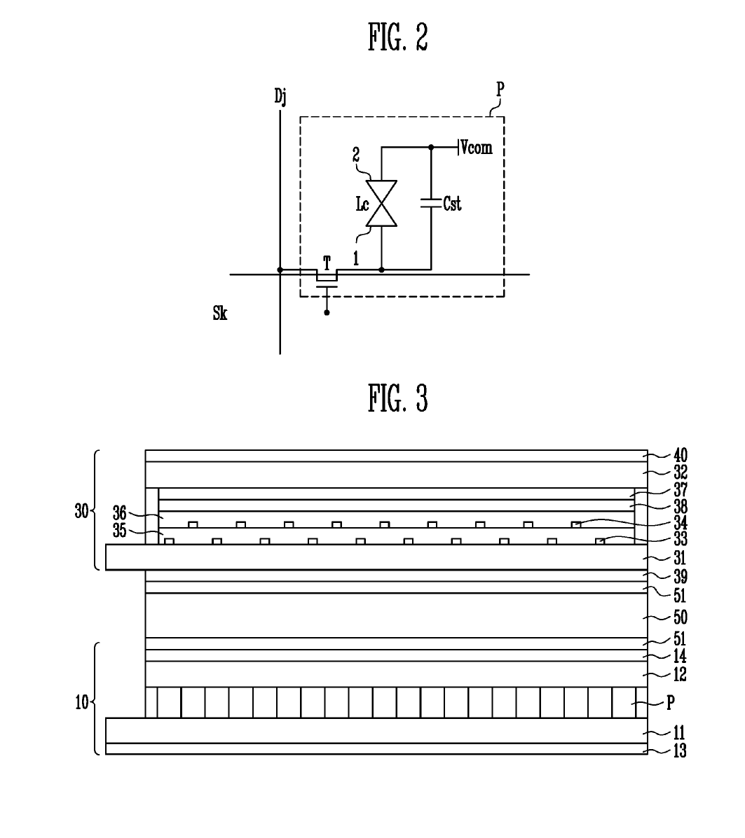

FIG. 1 is a block diagram illustrating an exemplary embodiment of a stereoscopic image display device, according to the invention. FIG. 2 is a circuit diagram illustrating an exemplary embodiment of a pixel of a display panel shown in FIG. 1. FIG. 3 is a cross-sectional view of an exemplary embodiment of the display panel and a liquid crystal lens, shown in FIG. 1.

Referring to FIGS. 1 to 3, an exemplary embodiment of the stereoscopic image display device includes a display panel 10, a liquid crystal lens panel 30, a scan driver 110, a data driver 120, a liquid crystal lens panel driver 130 and a timing controller 140. In such an embodiment, the display panel 10 may be implemented with a flat panel display such as a liquid crystal display (“LCD”), a field emission display (“FED”), a plasma display panel (“PDP”) or an organic light emitting display (“OLED”). Hereinafter, an exemplary embodiment where the display panel 10 is implemented with the LCD will be described for convenience of description, but the invention is not limited thereto.

The display panel 10 displays an image under the control of the timing controller 140. In the display panel 10, a liquid crystal layer is disposed between two substrates 11 and 12. In an exemplary embodiment, data lines D1 to Dm (m is a positive integer of 2 or greater) and scan lines (or gate lines) S1 to Sn (n is a positive integer of 2 or greater) are disposed to cross each other on a lower substrate 11 of the display panel 10. In such an embodiment, pixels P disposed substantially in a matrix form are disposed on the lower substrate 11 of the display panel 10. In one exemplary embodiment, for example, the pixels P may be disposed in cell areas defined by the data lines D1 to Dm and the scan lines S1 to Sn. Each pixel P of the display panel 10 includes a liquid crystal cell Lc coupled to a thin film transistor T to be driven by an electric field between a pixel electrode 1 and a common electrode 2 as shown in FIG. 2. The thin film transistor T supplies a data voltage of a j-th data line Dj (j is a positive integer satisfying 1≦j≦m) to the pixel electrode 1, in response to a scan signal of a k-th scan line Sk (k is a positive integer satisfying 1≦k≦n). Each pixel P includes a storage capacitor Cst for maintaining the voltage of the pixel electrode 1 for a predetermined period.

In an exemplary embodiment, a black matrix, a color filter and the like are disposed on an upper substrate 12 of the display panel 10. An upper polarizing plate 14 is disposed on or attached to the upper substrate 12 of the display panel 10, and a lower polarizing plate 13 is disposed on or attached to the lower substrate 11 of the display panel 10. The light transmission axes of the upper and lower polarizing plates 14 and 13 may be disposed substantially perpendicular to each other. In such an embodiment, alignment layers for setting a pre-tilt angle of liquid crystal molecules are respectively disposed on the upper and lower substrates 12 and 11. A spacer for maintaining a cell gap of the liquid crystal cells Lc is disposed between the upper and lower substrates 12 and 11 of the display panel 10. The common electrode 2 is disposed on the upper substrate 12 in a vertical electric field driving method, such as a twisted nematic (“TN”) mode a vertical alignment (“VA”) mode, or an electrically controlled birefringence (“ECB”) mode. The common electrode 2 is disposed, together with the pixel electrode 1, on the lower substrate 11 in a horizontal electric field driving method, such as an in-plane switching (“IPS”) mode or a fringe field switching (“FFS”) mode. The liquid crystal mode of the display panel 10 may be implemented as any liquid crystal mode, as well as the TN mode, the VA mode, the ECB mode, the IPS mode and the FFS mode, described above.

In an exemplary embodiment, the display panel 10 displays a 2D image in a 2D mode, and displays a stereoscopic image in a 3D mode. In such an embodiment, the timing controller 140 controls a 2D image data to be written in the display panel 10 in the 2D mode, and the timing controller 140 controls a 3D image data to be written in the display panel 10 in the 3D mode. In such an embodiment, a data DATA which the timing controller 140 supplies to the data driver 120 may be a 2D data in the 2D mode, and may be a 3D data in the 3D mode.

The stereoscopic image may be implemented as a multi-view image. The multi-view image includes a plurality of view images. The multi-view image may be generated by allowing cameras to be spaced apart from each other at an interval between both eyes of a normal person and photographing an image of an object with the cameras. When an object is photographed using four cameras, a multi-view image including four view images may be displayed as the stereoscopic image. In this case, the 3D image data may be a multi-view image data including four view image data. In a case where an object is photographed using two cameras, a multi-view image including two view images may be displayed as the stereoscopic image. In this case, the 3D image data may be a multi-view image data including two view image data such as left-image data and right-image data.

In an exemplary embodiment, the display panel 10 may be a transmissive liquid crystal display panel for modulating light from a backlight unit. In such an embodiment, the backlight unit includes a light source that emits light based on a driving current supplied from a backlight unit driver, a light guide plate (or diffusion plate), a plurality of optical sheets, and the like. The backlight unit may be implemented as a direct-type or edge-type backlight unit. The light source of the backlight unit may include a hot cathode fluorescent lamp (“HCFL”), a cold cathode fluorescent lamp (“CCFL”), an external electrode fluorescent lamp (“EEFL”), a light emitting diode (“LED”) or an organic light emitting diode.

The backlight unit driver generates the driving current to be provided to the light sources of the backlight unit. The backlight unit driver turns on/off the driving current supplied to the light sources under the control of a backlight controller. The backlight controller transmits, to the backlight driver, a backlight control data as a serial peripheral interface (“SPI”) data format, in response to a global/local dimming signal (“DIM”) input from a host system (not shown).

The data driver 120 includes a plurality of source drive integrated circuits (“IC”s). The source drive ICs generate positive/negative analog data voltages by converting a digital image data DATA input from the timing controller 140 into a positive/negative gamma compensation voltage. The positive/negative analog data voltages output from the source drive ICs are supplied to the data lines D1 to Dm of the display panel 10. The positive data voltage may be a voltage having a high level, e.g., a level higher than the common voltage supplied to the common electrode 2 in each pixel P, and the negative data voltage may be a voltage having a low level, e.g., a level lower than the common voltage supplied to the common electrode 2 in each pixel P.

The scan driver 140 includes a shift register for sequentially or progressively generating an output signal, a level shifter for shifting the output signal of the shift register to a swing width suitable for thin film transistor driving of the liquid crystal cell, an output buffer, and the like. The scan driver 140 sequentially or progressively supplies a scan signal synchronized with a data voltage to the scan lines S1 to Sn of the display panel 10 under the control of the timing controller 140. Accordingly, the data voltage is supplied to each pixel P to which the scan signal is supplied.

The timing controller 140 receives a digital image data DATA, timing signals and a mode signal MODE, input from the host system (not shown). The digital image data DATA is a digital data which expresses a gray scale. The timing signals may include a horizontal synchronization signal, a vertical synchronization signal, a data enable signal, a dot clock, and the like. The mode signal MODE is a signal capable of distinguishing the 2D mode from the 3D mode.

The timing controller 140 generates a scan driver control signal SCS for controlling the operation timing of the scan driver 110 and a data driver control signal DCS for controlling the operation timing of the data driver 120, based on the timing signals. The timing controller 140 supplies the scan driver control signal SCS to the scan driver 110. The timing controller 140 supplies the digital image data DATA and the data driver control signal DCS to the data driver 120.

The liquid crystal lens panel 30 is disposed on the display panel 10. Referring to FIG. 3, the liquid crystal lens panel 30 includes a first substrate 31, a second substrate 32, first division electrodes 33, second division electrodes 34, a first insulator 35, a second insulator 36, a common electrode 37, a liquid crystal layer 38, a first polarizing plate 39 and a second polarizing plate 40.

The first and second substrates 31 and 32 may include or be implemented with glass, plastic or film, for example. The first and second division electrodes 33 and 34 may have a double-layered structure on the first substrate 31. In an exemplary embodiment, the first division electrodes 33 are disposed on one surface of the first substrate 31, and the first insulator 35 is disposed on the first division electrodes 33 to cover the first division electrodes 33. The second division electrodes 34 are disposed on the first insulator 35, and the second insulator 36 is disposed on the second division electrodes 34 to cover the second division electrodes 34. The first insulator 35 may effectively prevent the occurrence of a short circuit between the first and second division electrodes 33 and 34. The second division electrodes 34 are respectively positioned between the first division electrodes 33. In such an embodiment, the second division electrodes 34 may be alternately disposed with the first division electrodes 33 when viewed from a top view.

The common electrode 37 may have a single-layered structure on one surface of the second substrate 32. The first polarizing plate 39 is attached on a surface (e.g., outer surface) of the first substrate 31, and the second polarizing plate 40 is attached on a surface (e.g. an outer surface) of the second substrate 32.

The liquid crystal layer 38 is disposed between the first and second substrates 31 and 32 of the liquid crystal lens panel 30. Liquid crystal molecules of the liquid crystal layer 38 are rotated by an electric field generated between the common electrode 37 and the first and second division electrodes 33 and 34. The liquid crystal lens panel 30 may be driven by a vertical electric field driving method such as the ECB mode.

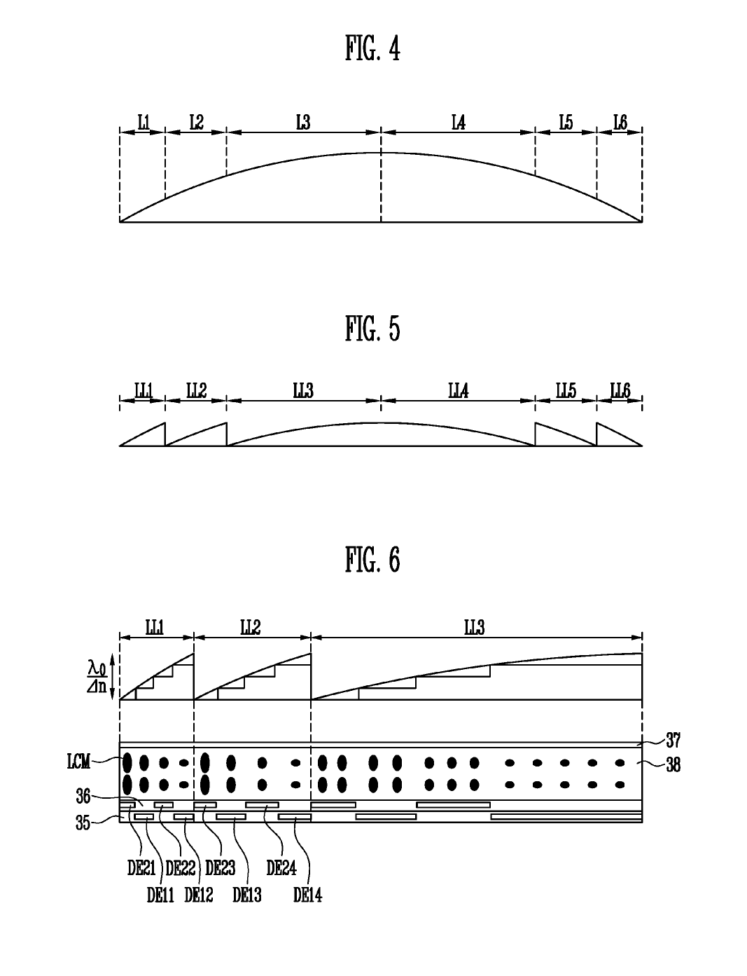

The liquid crystal layer 38 of the liquid crystal lens panel 30 may operate as a plurality of lenses L as shown in FIG. 1 by the electric field between the common electrode 37 and the first and second division electrodes 33 and 34. Each of the plurality of lenses L may be a slanted lens inclined by a predetermined angle as shown in FIG. 1. In such an embodiment, each of the plurality of lenses L may be a convex lens or a Fresnel lens. The Fresnel lens refers to a lens obtained by dividing a convex lens into some circular band-shaped lenses having a predetermined thickness to decrease the thickness of the convex lens. The convex lens and the Fresnel lens will be described later in greater detail with reference to FIGS. 4 and 5.

A gap glass 50 may be disposed between the display panel 10 and the liquid crystal lens panel 30. A thickness of the gap glass 50 may be set by a rear distance of the Fresnel lens formed in the liquid crystal layer 38 of the liquid crystal lens panel 30. The gap glass 50 may be adhered to the upper polarizing plate 14 of the display panel 10 and the first polarizing plate 39 of the liquid crystal lens panel 30, using an optical adhesive 51 such as an optically clear adhesive (“OCA”) film, for example.

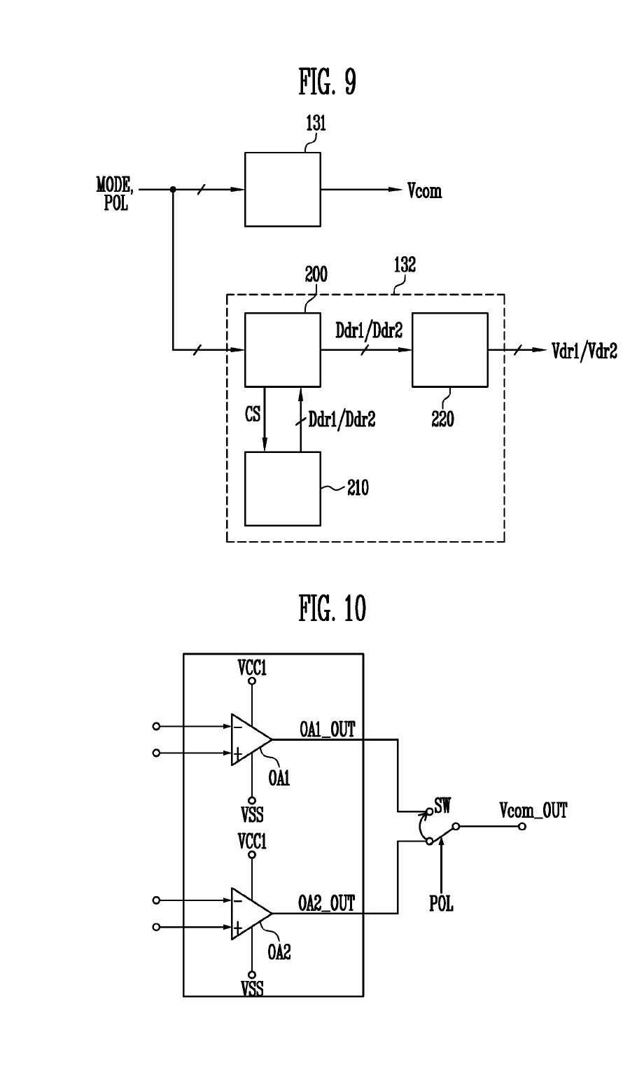

In an exemplary embodiment, the liquid crystal lens panel driver 130, as shown in FIG. 9, includes a common voltage supply unit 131 configured to supply a common voltage to the common electrode 37 of the liquid crystal lens panel 30, and a driving voltage supply unit 132 configured to supply driving voltages to the first and second division electrodes 33 and 34.

In an exemplary embodiment, the common electrode of the display panel 10 and the common electrode of the liquid crystal lens panel 30 are different components from each other. Thus, the common voltage supplied to the common electrode 37 of the liquid crystal lens panel 30 may be different from the common voltage supplied to the common electrode of the display panel 10. The liquid crystal lens panel driver 130 will be described later in greater detail with reference to FIG. 9.

As described above, an exemplary embodiment of the liquid crystal lens panel 30, e.g., the exemplary embodiment shown in FIGS. 1 to 3, allows a 2D image displayed in the display panel 10 to be transmitted as it is without refraction in the 2D mode. In such an embodiment, the liquid crystal lens panel 30 implements the liquid crystal layer as the lens L in the 3D mode, thereby separates view images displayed in the display panel 10 into view points. The view points are determined based on a number of view images. In one exemplary embodiment, for example, where a multi-view image includes four view images, the four view images are separated into four view points by the lens L of the liquid crystal lens panel 30. As a result, in such an embodiment, a user may watch a stereoscopic image without using a glasses.

FIG. 4 is a cross-sectional view of an exemplary embodiment of a convex lens. FIG. 5 is a cross-sectional view of an exemplary embodiment of a Fresnel lens. In an exemplary embodiment, the liquid crystal layer 38 of the liquid crystal lens panel 30 may be implemented as a convex lens as shown in FIG. 4 or as a Fresnel lens as shown in FIG. 5. The Fresnel lens refers to a lens obtained by dividing a convex lens into some circular band-shaped lenses having a predetermined thickness to decrease the thickness of the convex lens.

The Fresnel lens is implemented by dividing the convex lens into p (p is a positive integer of 2 or more) lens areas. In an exemplary embodiment, as shown in FIGS. 4 and 5, the Fresnel lens may be implemented by dividing the convex lens into 6 lens areas. In such an embodiment, each of the convex lens and the Fresnel lens includes first to sixth lens areas. In such an embodiment, a first lens area L1 of the convex lens corresponds to a first lens area LL1 of the Fresnel lens, a second lens area L2 of the convex lens corresponds to a second lens area LL2 of the Fresnel lens, and a third lens area L3 of the convex lens corresponds to a third lens area LL3 of the Fresnel lens. In such an embodiment, a fourth lens area L4 of the convex lens corresponds to a fourth lens area LL4 of the Fresnel lens, a fifth lens area L5 of the convex lens corresponds to a fifth lens area LL5 of the Fresnel lens, and a sixth lens area L6 of the convex lens corresponds to a sixth lens area LL6 of the Fresnel lens.

FIG. 6 is a cross-sectional view of the liquid crystal lens panel, in which the liquid crystal layer 38 is implemented as the Fresnel lens. For convenience of illustration, only the first to third lens areas LL1 to LL3 of the Fresnel lens, and portions of the first division electrodes 33, the second division electrodes 34, the first insulating layer 35, the second insulating layer 36, the common electrode 37 and the liquid crystal layer 38 in the liquid crystal lens panel 30 are illustrated in FIG. 6.

The liquid crystal layer 38 of the liquid crystal lens panel 30 is implemented as a plurality of Fresnel lenses in the 3D mode. In an exemplary embodiment, each Fresnel lens, as shown in FIG. 4, may be divided into first to sixth lens areas LL1 to LL6. As shown in FIG. 4, the shapes of the lenses in the first to sixth lens area LL1 to LL6 are different from one another. Each of the first to sixth lens areas LL1 to LL6 may have j (j is a positive integer of 2 or more) first division electrodes 33 and j second division electrodes 34, which are disposed therein. In an exemplary embodiment, two first division electrodes 33 and two second division electrodes 34 may be disposed in each of the first to sixth lens areas LL1 to LL6 as shown in FIG. 6, but the invention is not limited thereto. As the number of the first and second division electrodes 33 and 34 disposed in each of the first to sixth lens areas LL1 to LL6 increases, the liquid crystal layer 38 of the liquid crystal lens panel 30 may be implemented as the Fresnel lens more effectively. In an exemplary embodiment, as shown in FIG. 6, the size (width) of each of the first and second division electrodes 33 and 34 may be changed based on the size (width) of the lens area.

Liquid crystal molecules LCM of the liquid crystal layer 38 are rotated according to an electric filed corresponding to the difference between a driving voltage supplied to each division electrode and a common voltage supplied to the common electrode 37. In the ECB mode, as the difference between the driving voltage and the common voltage becomes large, the liquid crystal molecules LCM becomes close to a normal state (θ=90°, where θ denotes an angle of a longitudinal axis of a liquid crystal molecule with respect to a surface of a substrate 31 or 32 of the liquid crystal lens panel 30) in which the liquid crystal molecules LCM are aligned along the direction of an electric field, and thus light incident onto the liquid crystal layer 38 is further diffracted. In the ECB mode, as the difference between the driving voltage and the common voltage becomes small, the liquid crystal molecules LCM becomes close to an initial alignment state (θ=0°), and thus light incident onto the liquid crystal layer 38 is less diffracted. Therefore, in an exemplary embodiment, the difference between the driving voltage supplied to each of the first and second division electrodes 33 and 34 and the common voltage supplied to the common electrode 37 in each of the first to sixth lens areas LL1 to LL6 decreases as it approaches the center of the Fresnel lens to implement the liquid crystal layer 38 of the liquid crystal lens panel 30 to operate as the

Fresnel lens.

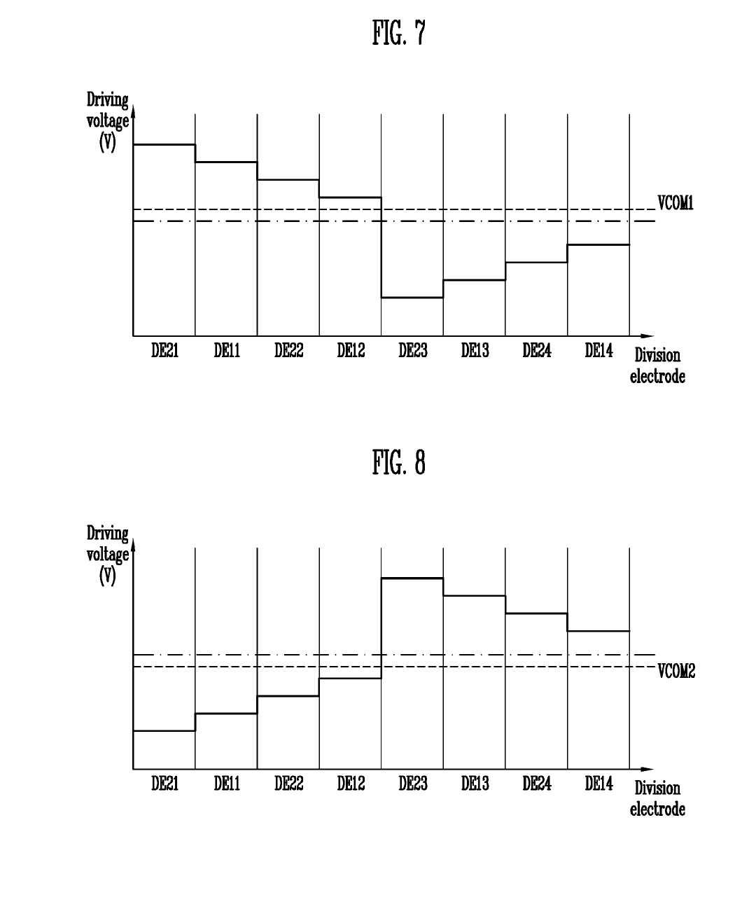

In one exemplary embodiment, for example, as shown in FIG. 6, among a first second division electrode DE21, a first first division electrode DE11, a second second division electrode DE22 and a second first division electrode DE12 disposed in the first lens area LL1, the first second division electrode DE21 is most distant from the center of the Fresnel lens, and the second first division electrode DE12 is closest to the center of the Fresnel lens. Therefore, in such an embodiment, as shown in FIGS. 7 and 8, the difference between the driving voltage supplied to the first second division electrode DE21 and the common voltage is largest, the difference between the driving voltage supplied to the first first division electrode DE11 and the common voltage is second largest, the difference between the driving voltage supplied to the second second division electrode DE22 and the common voltage is third largest, and the difference between the driving voltage supplied to the second first division electrode DE12 and the common voltage is smallest.

Among a third first division electrode DE13, a third second division electrode DE23, the fourth second DE24 and a fourth first division electrode DE14 disposed in the second lens area LL2, the third second division electrode DE23 is most distant from the center of the Fresnel lens, and the fourth first division electrode DE14 is closest to the center of the Fresnel lens. Therefore, in such an embodiment, as shown in FIGS. 7 and 8, the difference between the driving voltage supplied to the third second division electrode DE23 and the common voltage is largest, the difference between the driving voltage supplied to the third first division electrode DE13 and the common voltage is second largest, the difference between the driving voltage supplied to the fourth second division electrode DE24 and the common voltage is third largest, and the difference between the driving voltage supplied to the fourth first division electrode DE14 and the common voltage is smallest.

In an exemplary embodiment, the first to fourth first division electrodes DE11, DE12, DE13 and DE14 shown in FIG. 6 may correspond to the first division electrodes 33 shown in FIG. 3, and the first to fourth second division electrodes DE21, DE22, DE23 and DE24 may correspond to the second division electrodes 34 shown in FIG. 3.

In an exemplary embodiment, no voltage is applied to the first and second division electrodes 33 and 34 and the common electrode 37 of the liquid crystal lens panel 30 in the 2D mode, and therefore, the liquid crystal layer 38 allows light incident thereonto to be transmitted as it is without refraction.

In an exemplary embodiment, as described with reference to FIG. 6, the liquid crystal layer 38 of the liquid crystal lens panel 30 is implemented as Fresnel lens, such that the thickness of the liquid crystal layer 38 may be substantially decreased, as compared a case where the liquid crystal layer 38 is implemented as the convex lens. As a result, the amount of liquid crystal molecules injected into the liquid crystal layer 38 may be decreased in such an embodiment, thereby reducing the cost of manufacturing thereof.

FIG. 7 is a diagram illustrating a common voltage supplied to the common electrode and driving voltages supplied to the division electrodes in an exemplary embodiment during an N-th frame period. FIG. 8 is a diagram illustrating a common voltage supplied to the common electrode and driving voltages supplied to the division electrodes in an exemplary embodiment during an (N+1)-th frame period.

Driving voltages respectively supplied to the first to fourth first division electrodes DE11, DE12, DE13 and DE14 and the first to fourth second division electrodes DE21, DE22, DE23 and DE24, which are disposed in the first and second lens areas LL1 and LL2 of the liquid crystal lens panel 30 shown in FIG. 6, are shown in FIGS. 7 and 8. In FIGS. 7 and 8 that, for convenience of illustration, driving voltages of an exemplary embodiment, where positive driving voltages are supplied to the first and second first division electrodes DE11 and DE12 and the first and second second division electrodes DE21 and DE 22, and negative driving voltages are supplied to the third and fourth first division electrodes DE13 DE14 and the third and fourth second division electrodes DE23 and DE24 during the N-th frame period, and negative driving voltages are supplied to the first and second first division electrodes DE11 and DE12 and the first and second second division electrodes DE21 and DE22, and positive driving voltages are supplied to the third and fourth first division electrodes DE13 and DE14 and the third and fourth second division electrodes DE23 and DE24 during the (N+1)-th frame period, are shown, but the invention is not limited thereto. The positive data voltage refers to a voltage higher than the common voltage Vcom, and the negative data voltage refers to a voltage lower than the common voltage Vcom.

Hereinafter, the driving voltages supplied to the division electrodes and the common voltage supplied to the common electrode 37 to implement the liquid crystal layer 38 of the liquid crystal lens panel 30 to operate as the Fresnel lens will be described with reference to FIGS. 6, 7 and 8.

Referring to FIGS. 6, 7 and 8, in an exemplary embodiment, when driving voltages of a first polarity are supplied to division electrodes disposed in a q-th (q is a positive integer satisfying 1≦q≦p) lens area during the N-th frame period, driving voltages of a second polarity are supplied to the division electrodes during the (N+1)-th frame period. In one exemplary embodiment, for example, as shown in FIGS. 7 and 8, positive driving voltages are supplied to the first second division electrode DE21, the first first division electrode DE11, the second second division electrode DE22 and the second first division electrode DE12 disposed in the first lens area LL1 during the N-th frame period, and negative driving voltages are supplied to the first second division electrode DE21, the first first division electrode DE11, the second second division electrode DE22 and the second first division electrode DE12 during the (N+1)-th frame period. In such an embodiment, driving voltages of the second polarity are supplied to division electrodes disposed in a lens area adjacent to the q-th lens area during the N-th frame period, and driving voltages of the first polarity are supplied to the division electrodes disposed in the lens area adjacent to the q-th lens area during the (N+1)-th frame period. In one exemplary embodiment, for example, as shown in FIGS. 7 and 8, negative driving voltages are supplied to the third second division electrode DE23, the third first division electrode DE13, the fourth second division electrode DE24 and the fourth first division electrode DE14 disposed in the second lens area LL2 adjacent to the first lens area LL1 during the N-th frame period, and positive driving voltages are supplied to the third second division electrode DE23, the third first division electrode DE13, the fourth second division electrode DE24 and the fourth first division electrode DE14 disposed in the second lens area LL2 adjacent to the first lens area LL1 during the (N+1)-th frame period.

In such an embodiment, driving voltages of different polarities from each other are supplied to the division electrodes disposed in the q-th lens area during the respective N-th and (N+1)-th frame periods, and the polarity of the driving voltages supplied to the division electrodes disposed in the q-th lens area and the polarity of the driving voltages supplied to the division electrodes disposed in the lens area adjacent to the q-th lens area are controlled to be opposite to each other, thereby maximizing the difference in voltage between the division electrodes positioned at the boundary between the lens areas. As a result, in such an embodiment, the alignment state of liquid crystal molecules at the boundary between the lens areas may be substantially precisely controlled, such that the liquid crystal layer 38 of the liquid crystal lens panel 30 may be implemented to operate as the Fresnel lens more effectively. In one exemplary embodiment, for example, the liquid crystal molecules between the second first division electrode DE12 in the first lens area LL1 and the common electrode 37 are aligned in the initial alignment state (θ=0°), and the liquid crystal molecules between the third second division electrode DE23 in the second lens area LL2 and the common electrode 37 are aligned in the normal state (θ=90°) in which the liquid crystal molecules are aligned along the direction of an electric field. In such an embodiment, the alignment state of the liquid crystal molecules between the second first division electrode DE12 in the first lens area LL1 and the common electrode 37 and the alignment state of the liquid crystal molecules between the third second division electrode DE23 in the second lens area LL2 and the common electrode 37 can be exactly controlled by maximizing the difference between the driving voltage supplied to the second first division electrode DE12 in the first lens area LL1 and the driving voltage supplied to the third second division electrode DE23 in the second lens area LL2.

In an exemplary embodiment, when driving voltages of different polarities from each other are supplied to the division electrodes disposed in the q-th lens area during the respective N-th and (N+1)-th frame periods, and the polarity of the driving voltages supplied to the division electrodes disposed in the q-th lens area and the polarity of the driving voltages supplied to the division electrodes disposed in the lens area adjacent to the q-th lens area are controlled to be opposite to each other, the average polarity of driving voltages supplied to the liquid crystal lens panel may be biased to the positive or negative polarity according to a frame period. In one exemplary embodiment, for example, the average polarity of the driving voltages supplied to the liquid crystal lens panel may be biased to the positive polarity during the N-th frame period, and may be biased to the negative polarity during the (N+1)-th frame period. In such an embodiment, a difference between the luminance of an image during the N-th frame period and the luminance of an image during the (N+1)-th frame period may occurs due to the difference in the response characteristic and RC delay of the liquid crystal molecules between the positive and negative polarities. According, a user may feel flickering in which a periodic change in the luminance of a display device is recognized through a visual angle. Therefore, the user may feel inconvenience in watching 2D or 3D images.

Accordingly, in an exemplary embodiment, a first common voltage Vcom1 is supplied during the N-th frame period, and a second common voltage Vcom2 having a level lower than a level of the first common voltage Vcom1 is supplied during the (N+1)-th frame period. In one exemplary embodiment, for example, the first common voltage Vcom1 that decreases the difference between the positive driving voltages and the common voltage is supplied to the common electrode 37 of the liquid crystal lens panel 30 as the common voltage during the N-th frame period in which the average polarity of the driving voltages supplied to the liquid crystal lens panel 30 is biased to the positive polarity. In such an embodiment, the second common voltage Vcom2 that decreases the difference between the negative driving voltages and the common voltage is supplied to the common electrode 37 of the liquid crystal lens panel 30 as the common voltage during the (N+1)-th frame period in which the average polarity of the driving voltages supplied to the liquid crystal lens panel 30 is biased to the negative polarity. In such an embodiment, as the difference between the driving voltages supplied to the division electrodes and the common voltage decreases, the difference between the luminance of an image during the N-th frame period and the luminance of an image during the (N+1)-th frame period is substantially reduced or effectively minimized. In such an embodiment, the difference in level between the driving voltages supplied to the division electrodes and the common electrode may be decreased, and the difference between the luminance of an image during the N-th frame period and the luminance of an image during the (N+1)-th frame period is thereby substantially reduced or effectively minimized. Accordingly, in such an embodiment, image quality is substantially improved by reducing flickering.

FIG. 9 is a block diagram illustrating an exemplary embodiment of a liquid crystal lens panel driver, according to the invention.

Referring to FIG. 9, an exemplary embodiment of the liquid crystal lens panel driver 130 includes a common voltage supply unit 131 and a driving voltage supply unit 132.

The common voltage supply unit 131 receives a mode signal MODE and a polarity control signal POL from the timing controller 140. The common voltage supply unit 131 may determine the mode of an image as the 2D or 3D mode based on the mode signal MODE. In one exemplary embodiment, for example, the common voltage supply unit 131 determines the mode of the image as the 2D mode when the mode signal MODE having a first logic level voltage is input thereto, and determines the mode of the image as the 3D mode when the mode signal MODE having a second logic level voltage is input thereto.

The common voltage supply unit 131 does not supply the common voltage to the common electrode 37 of the liquid crystal lens panel 30 in the 2D mode. The common voltage supply unit 131 supplies the common voltage as an alternating current (“AC”) voltage to the common electrode 37 of the liquid crystal lens panel 30 in the 3D mode. In such an embodiment, the common voltage supply unit 131 may output the common voltage by regulating the level of the common voltage based on the polarity control signal POL in the 3D mode. The common voltage supply unit 131 outputs a first common voltage Vcom1 as the common voltage Vcom when the polarity control signal POL having a first logic level voltage is input thereto, and outputs a second common voltage Vcom2 as the common voltage Vcom when the polarity control signal POL having a second logic level voltage is input thereto. The first common voltage Vcom1 is a voltage having a level higher than a level of the second common voltage Vcom2.

In an exemplary embodiment, the polarity control signal POL may be generated as the first logic level voltage during the N-th frame period, and may be generated as the second logic level voltage during the (N+1)-th frame period. In such an embodiment, the common voltage supply unit 131 supplies the first common voltage Vcom1 as the common voltage Vcom during the N-th frame period, and supplies the second common voltage Vcom2 as the common voltage Vcom during the (N+1)-th frame period. The common voltage supply unit 131 will be described later in greater detail with reference to FIG. 10.

The driving voltage supply unit 132 receives the mode signal MODE and the polarity control signal POL, which are input from the timing controller 140. The driving voltage supply unit 132 may determine the mode of an image as the 2D or 3D mode based on the mode signal MODE. The driving voltage supply unit 132 does not supply the driving voltages to the liquid crystal lens panel 30 in the 2D mode. The driving voltage supply unit 132 supplies the driving voltages to the liquid crystal lens panel 30 in the 3D mode.

In an exemplary embodiment, the driving voltage supply unit 132 includes a driving voltage supply controller 200, a look-up table 210 and a digital-analog converter 220. The driving voltage supply controller 200 determines whether to supply a driving voltage is supplied based on the 2D or 3D mode. The driving voltage supply controller 200 does not output a driving voltage data to the digital-analog converter 220 in the 2D mode. In the 3D mode, the driving voltage supply controller 200 receives a driving voltage data input from the look-up table 210 based on the polarity control signal POL, and outputs the input driving voltage data to the digital-analog converter 220.

In an exemplary embodiment, the driving voltage supply controller 200 generates a control signal CS based on the polarity control signal POL and outputs the generated control signal CS to the look-up table 210. The look-up table 210 supplies the driving voltage data to the driving voltage supply controller 200 based on the control signal CS. The driving voltage supply controller 200 may output the control signal CS having a first logic level voltage when the polarity control signal POL having the first logic level voltage is input, and may output the control signal CS having a second logic level voltage when the polarity control signal POL having the second logic level voltage is input.

In such an embodiment, when the first common voltage Vcom1 is supplied to the common electrode 37 of the liquid crystal lens panel 30 as the common voltage Vcom, the look-up table 210 stores a first driving voltage data Ddr1 corresponding to first driving voltages Vdr1 supplied to the division electrodes 33 and 34 of the liquid crystal lens panel 30. In such an embodiment, when the second common voltage Vcom2 is supplied to the common electrode 37 of the liquid crystal lens panel 30 as the common voltage Vcom, the look-up table 210 stores a second driving voltage data Ddr2 corresponding to second driving voltages Vdr2 supplied to the division electrodes 33 and 34 of the liquid crystal lens panel 30. The first driving voltages Vdr1 are voltages supplied to control the liquid crystal molecules such that the liquid crystal layer 38 of the liquid crystal lens panel 30 operates as the Fresnel lens when the first common voltage Vcom1 is supplied to the common electrode 37 of the liquid crystal lens panel 30 as the common voltage Vcom. The second driving voltages Vdr2 are voltages supplied to control the liquid crystal molecules so that the liquid crystal layer 38 of the liquid crystal lens panel 30 operates as the Fresnel lens when the second common voltage Vcom2 is supplied to the common electrode 37 of the liquid crystal lens panel 30 as the common voltage Vcom. The look-up table 210 outputs the first driving voltage data Ddr1 when the control signal CS having the first logic level voltage is input, and outputs the second driving voltage data Ddr2 when the control signal CS having the second logic level voltage is input.

The digital-analog converter 220 receives the first or second driving voltage data Ddr1 or Ddr2 input from the driving voltage supply controller 200. The digital-analog converter 220 converts the first driving voltage data Ddr1 in digital format into first driving voltages Vdr1 corresponding to analog voltages and output the converted first driving voltages Vdr1. The digital-analog converter 220 converts the second driving voltage data Ddr2 in digital format into second driving voltages Vdr2 corresponding to analog voltages and output the converted second driving voltages Vdr2. The first driving voltages Vdr1 or the second driving voltages Vdr2 are supplied to the first and second division electrodes 33 and 34 of the liquid crystal lens panel 30.

In an exemplary embodiment, the polarity control signal POL may be generated as a first logic level voltage during the N-th frame period, and may be generated as a second logic level voltage during the (N+1)-th frame period. In such an embodiment, during the N-th frame period, the driving voltage supply controller 200 receives a first driving voltage data Ddr1 input from the look-up table 210 and outputs the input first driving voltage data Ddr1 to the digital-analog converter 220. The digital-analog converter 220 converts the first driving voltage data Ddr1 into first driving voltages Vdr1 and outputs the converted first driving voltages Vdr1. Thus, in such an embodiment, the first driving voltages Vdr1 are supplied to the first and second division electrodes 33 and 34 of the liquid crystal lens panel 30 during the N-th frame period. During the (N+1)-th frame period, the driving voltage supply controller 200 receives a second driving voltage data Ddr2 input from the look-up table 210 and outputs the input second driving voltage data Ddr2 to the digital-analog converter 220. The digital-analog converter 220 converts the second driving voltage data Ddr2 into second driving voltages Vdr2 and outputs the converted second driving voltages Vdr2.

Thus, in such an embodiment, the second driving voltages Vdr2 are supplied to the first and second division electrodes 33 and 34 of the liquid crystal lens panel 30 during the (N+1)-th frame period.

As described above, in an exemplary embodiment, the common voltage and the driving voltages are not supplied to the liquid crystal lens panel 30 in the 2D mode. In such an embodiment, when the polarity control signal POL having the first logic level voltage is input in the 3D mode, the first common voltage Vcom1 and the first driving voltages Vdr1 are supplied to the liquid crystal lens panel 30. In such an embodiment, when the polarity control signal POL having the second logic level voltage is input in the 3D mode, the second common voltage Vcom2 and the second driving voltages Vdr2 are supplied to the liquid crystal lens panel 30.

FIG. 10 is a circuit diagram illustrating an exemplary embodiment of the common voltage supply unit 131 of FIG. 9.

Referring to FIG. 10, an exemplary embodiment of the common voltage supply unit 131 includes first and second operational amplifiers OA1 and OA2 and a switch SW.

The first operational amplifier OA1 is configured to output the first common voltage Vcom1 based on voltages respectively input to a non-inverting input terminal (−) and an inverting input terminal (+) thereof. The second operational amplifier OA2 is configured to output the second common voltage Vcom2 having a voltage level lower than the level of the first common voltage Vcom1 based on voltages respectively input to a non-inverting input terminal (−) and an inverting input terminal (+) thereof In such an embodiment, as shown in FIG. 10, power supply voltages VCC1 and VSS are applied to the first and second operational amplifier OA1 and OA2.

The switch SW allows any one of an output terminal OA1_OUT of the first operational amplifier OA2 and an output terminal OA2_OUT of the second operational amplifier OA2 to be coupled to a common voltage output terminal Vcom_OUT based on the polarity control signal POL. In an exemplary embodiment, the switch SW allows the output terminal OA1_OUT of the first operational amplifier OA1 to be coupled to the common voltage output terminal Vcom_OUT, in response to the polarity control signal POL having the first logic level voltage, such that the first common voltage Vcom1 is output to the common electrode 37 of the liquid crystal lens panel 30 through the common voltage output terminal Vcom_OUT. The switch SW allows the common voltage output terminal Vcom_OUT to be coupled to the output terminal OA2_OUT of the second operational amplifier OA2, in response to the polarity control signal POL having the second logic level voltage, such that the second common voltage Vcom2 is output to the common electrode 37 of the liquid crystal lens panel 30 through the common voltage output terminal Vcom_OUT.

As described above, in an exemplary embodiment, any one of the first and second common voltages Vcom1 and Vcom2 may be output based on the polarity control signal POL. As a result, the common voltage may be supplied by being swung every predetermined period in the 3D mode.

In exemplary embodiments as set forth herein, the first common voltage is supplied to the common electrode of the liquid crystal lens panel during the N-th frame period in which the average polarity of the driving voltages supplied to the liquid crystal lens panel is biased to the positive polarity. The first common voltage refers to a voltage that decreases the difference between the positive driving voltages and the common voltage. In such an embodiment, the second common voltage is supplied to the common electrode of the liquid crystal lens panel during the (N+1)-th frame period in which the average polarity of the driving voltages supplied to the liquid crystal lens panel is biased to the negative polarity. The second common voltage is a voltage that decreases the difference between the negative driving voltages and the common voltage. In such an embodiment, as the difference between the driving voltages supplied to the division electrodes and the common voltage decreases, the difference between the luminance of an image during the N-th frame period and the luminance of an image during the (N+1)-th frame period is substantially reduced or effectively minimized As a result, the difference in level between the driving voltages supplied to the division electrodes and the common electrode may be decreased, as compared with a conventional display device including a liquid crystal lens panel. Therefore, in such an embodiment, the difference between the luminance of an image during the N-th frame period and the luminance of an image during the (N+1)-th frame period is substantially reduced or effectively minimized, thereby substantially improving image quality by reducing flickering.

Some exemplary embodiments have been disclosed herein, and although specific terms are employed, they are used and are to be interpreted in a generic and descriptive sense only and not for purpose of limitation. In some instances, as would be apparent to one of ordinary skill in the art as of the filing of the application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the invention as set forth in the following claims.

What is claimed is:

1. A stereoscopic image display device comprising:
a display panel comprising a plurality of pixels;
a liquid crystal lens panel disposed above the display panel, wherein the liquid crystal lens panel comprises:
a first substrate;
a second substrate disposed opposite to the first substrate;
division electrodes disposed on the first substrate;
a common electrode disposed on the second substrate; and
a liquid crystal layer disposed between the first and second substrates;
a common voltage supply unit configured to supply a common voltage to the common electrode; and
a driving voltage supply unit configured to supply driving voltages to the division electrodes,
wherein the liquid crystal layer of the liquid crystal lens panel is implemented as a plurality of lenses by an electric field generated based on the driving voltages supplied to the division electrodes and the common voltage supplied to the common electrode, and
wherein the common voltage is driven as an alternating current voltage.

2. The stereoscopic image display device of claim 1, wherein
the common voltage supply unit supplies a first common voltage to the common electrode during an N-th frame period, and supplies a second common voltage having a level lower than a level of the first common voltage to the common electrode during an (N+1)-th frame period, wherein N is a positive integer.

3. The stereoscopic image display device of claim 2, wherein
each of the plurality of lenses is divided into p lens areas, wherein p is a positive integer equal to or greater than 2, and
the driving voltage supply unit supplies driving voltages of a first polarity to the division electrodes disposed in a q-th lens area during the N-th frame period, and supplies driving voltages of a second polarity to the division electrodes disposed in the q-th lens area during the (N+1)-th frame period, wherein q is a positive integer satisfying the following inequation: 1≦q≦p.

4. The stereoscopic image display device of claim 3, wherein
the driving voltage supply unit supplies the driving voltages of the second polarity to the division electrodes disposed in a lens area adjacent to the q-th lens area during the N-th frame period, and supplies the driving voltages of the first polarity to the division electrodes disposed in the lens area adjacent to the q-th lens area during the (N+1)-th frame period.

5. The stereoscopic image display device of claim 2, wherein
the common voltage supply unit supplies the first common voltage to the common electrode, in response to a polarity control signal having a first logic level voltage, and
the common voltage supply unit supplies the second common voltage to the common electrode, in response to a polarity control signal having a second logic level voltage.

6. The stereoscopic image display device of claim 5, wherein the common voltage supply unit comprises:
a first operational amplifier configured to output the first common voltage;
a second operational amplifier configured to output the second common voltage; and
a switch configured to allow an output terminal of the common voltage supply unit to be coupled to an output terminal of the first operational amplifier when the polarity control signal having the first logic level voltage is input, and to allow the output terminal of the common voltage supply unit to be coupled to an output terminal of the second operational amplifier when the polarity control signal having the second logic level voltage is input.

7. The stereoscopic image display device of claim 2, wherein the driving voltage supply unit comprises:
a look-up table configured to store a first driving voltage data to be supplied during the N-th frame period and a second driving voltage data to be supplied during the (N+1)-th frame period;
a digital-analog converter configured to convert the first driving voltage data into first driving voltages and output the converted first driving voltages, and to convert the second driving voltage data into second driving voltages and output the converted second driving voltages; and
a driving voltage supply controller configured to receive the first driving voltage data input from the look-up table and output the input first driving voltage data to the digital-analog converter when a polarity control signal having the first logic level voltage is input thereto, and to receive the second driving voltage data input from the look-up table and output the input second driving voltage data to the digital-analog converter when a polarity control signal having the second logic level voltage is input thereto.

8. The stereoscopic image display device of claim 2, wherein
the N-th frame period corresponds to a period in which the average polarity of the driving voltages supplied to the liquid crystal lens panel is biased to a positive polarity, and
the (N+1)-th frame period corresponds to a period in which the average polarity of the driving voltages supplied to the liquid crystal lens panel is biased to a negative polarity.

9. A method of driving a stereoscopic image display device comprising a display panel, and a liquid crystal lens panel disposed above the display panel, the method comprising:
transmitting light incident onto a liquid crystal layer of the liquid crystal lens panel without refraction in a two-dimensional mode, wherein the liquid crystal layer is disposed between a first substrate and a second substrate of the liquid crystal lens panel, which are disposed opposite to each other; and
generating an electric field based on driving voltages and a common voltage supplied to the liquid crystal lens panel in a three-dimensional mode to implement the liquid crystal layer as a plurality of lenses, wherein the driving voltages are supplied to division electrodes disposed in the first substrate of the liquid crystal lens panel and the common voltage is supplied to a common electrode disposed in the second substrate of the liquid crystal lens panel,
wherein the common voltage is driven as an alternating current voltage in the three-dimensional mode.

10. The method of claim 9, wherein the generating the electric field based on the driving voltages and the common voltage supplied to the liquid crystal lens panel in the three-dimensional mode comprises:
supplying a first common voltage to the common electrode during an N-th frame period; and
supplying a second common voltage lower than the first common voltage to the common electrode during an (N+1)-th frame period,
wherein N is a positive integer.

11. The method of claim 10, wherein
each of the plurality of lens is divided into p lens areas, wherein p is a positive integer equal to or greater than 2, and
the generating the electric field based on the driving voltages and the common voltage supplied to the liquid crystal lens panel in the three-dimensional mode comprises:
supplying the driving voltages of a first polarity to the division electrodes disposed in a q-th lens area during the N-th frame period; and
supplying the driving voltages of a second polarity to the division electrodes disposed in the q-th lens area during the (N+1)-th frame period,
wherein q is a positive integer satisfying the following inequation: 1≦q≦p.

12. The method of claim 11, wherein the generating the electric field based on the driving voltages and the common voltage supplied to the liquid crystal lens panel in the three-dimensional mode further comprises:
supplying the driving voltages of the second polarity to the division electrodes disposed in a lens area adjacent to the q-th lens area during the N-th frame period; and
supplying the driving voltages of the first polarity to the division electrodes disposed in the lens area adjacent to the q-th lens area during the (N+1)-th frame period.

13. The method of claim 10, wherein the generating the electric field based on the driving voltages and the common voltage supplied to the liquid crystal lens panel in the three-dimensional mode further comprises:
supplying the first common voltage to the common electrode in response to a polarity control signal having a first logic level voltage during the N-th frame period.

14. The method of claim 10, wherein the generating the electric field based on the driving voltages and the common voltage supplied to the liquid crystal lens panel in the three-dimensional mode further comprises:
supplying the second common voltage to the common electrode in response to a polarity control signal having a second logic level voltage during the (N+1)-th frame period.

15. The method of claim 10, wherein
the N-th frame period corresponds to a period in which the average polarity of the driving voltages supplied to the liquid crystal lens panel is biased to a positive polarity, and
the (N+1)-th frame period corresponds to a period in which the average polarity of the driving voltages supplied to the liquid crystal lens panel is biased to a negative polarity.
